(19) United States
(12) Patent Application Publication
(10) Pub. No.: US 2015/0230434 A1
(43) Pub. Date: Aug. 20, 2015

(54) Application of Green Technology Techniques to Construct a Biodegradable Artificial Reef

(71) Applicant: Thomas J. Manning, Hahira, GA (US)

(72) Inventor: Thomas J. Manning, Hahira, GA (US)

(21) Appl. No.: 14/181,606

(22) Filed: Feb. 14, 2014

(51) Int. Cl. A01K 61/00

(52) U.S. Cl. CPC A01K 61/006

(57) ABSTRACT

Artificial reefs serve a useful purpose to promote the growth of sessile marine organisms such as bacteria, algae, corals, and bryozoans as well as providing a habitat and food source for species such as fish, crabs, lobsters, and some marine invertebrates. This invention applies the United States Environmental Protection Agencies' Twelve Principles of Green Technology to provide a cellulose based surface that is coated in nutrients to promote the rapid growth of marine microbes, the base of the marine food chain. This rapid growth, which begins days after being submerged, starts the food chain. The mineral based substrate attached to the cellulose based material is denser than water to allow the entire structure to sink; both the cellulose and mineral based materials will degrade rapidly leaving behind nucleation sites for microbes, corals, invertebrate collections, and more. The reef is constructed entirely from biodegradable materials and production costs are economical.

### BACKGROUND

1. Field of the Invention

A cellulose based material is soaked in nutrients, combined with a mineral based biodegradable substrate, sunk in an aquatic or marine environment and used to function as a nucleation and nutrition site for a variety of organisms. As opposed to other approaches for constructing artificial reefs, this method utilizes green technologies' principles to stimulate the rapid colonization of the structure by the microbial community, the bottom of the food chain, shortly after being submerged.

2. Description of the Related Articles

Artificial reefs utilized in a marine environment are routinely constructed from metal ships, rocks, and cement blocks. These relatively inert materials can take years to start a marine ecosystem and over several decades offer no chance of being biodegradable or sustainable. They can leave a significant environmental mark on the ocean floor with high levels of materials, such as nickel, chromium and PCB's, released from decaying structures. In many cases, this approach can take years to plan and cost millions of dollars (i.e. sinking a ship). Our approach is sustainable, relatively cheap, and constructed from biodegradable materials. Outlining prior articles, commencing with the inventions revealed in United States patent data base is important to put forth the uniqueness and relevance of this invention:

U.S. Pat. No. 8,413,609 describes a trapping basket that is adapted to contain the hardground animals that are harvested from the ocean. U.S. Pat. No. 8,312,843 described a material used to stimulate marine growth but includes materials such as cement and peanuts and subsequently would not be biodegradable. U.S. Pat. No. 6,451,722 was awarded to Kim for the construction of an artificial reef based on various industrial wastes including sludge's, red mud, and blast furnace slag. U.S. Pat. No. 5,836,265 describes an artificial reef ball that is constructed from cement and is perforated. U.S. Pat. No. 6,464,429 describes a series of connected plates used for growing coral. Laurie et al. were awarded a U.S. Pat. No. 4,095,560 entitled “Baled Tire Process”. It focuses on the use of old tires in the construction of an artificial reef. U.S. Pat. No. 5,823,710 describe the use of timber to remediate stream but does not reveal its role in growing microbes or being treated with nutrients or having the ability to sink below the water. U.S. Pat. No. 7,285,238 describes the formation of an artificial reef by pouring a moldable material into a reef mold and letting it harden. This material is not biodegradable and constructed of inert material. Kikuzawa et al. was granted a United States patent (U.S. Pat. No. 4,465,399) for their discovery entitled, “Artificial reef assembly construction and a method.” The invention involved the land construction of a structure and its subsequent towing by ship to a pre-designated location at sea. Walter (U.S. Pat. No. 6,824,327) was awarded a patent entitled Artificial Barrier Reef. It outlined a design incorporating a skeletal frame and support beams aimed at stimulating marine life. Streichenberger was awarded U.S. Pat. No. 6,056,476 for the invention entitled “Near off-bottom cultivation of kelp forests”. The disclosure was aimed at cultivating seaweed on lines in the ocean. U.S. Pat. No. 7,997,231 describes the blending of calcium carbonate an a resin to form a material that can be used in the repair of an artificial reef. Ferguson was awarded U.S. Pat. No. 4,648,749 for the invention entitled “Method and apparatus for constructing an artificial island”. It focused on an invention related to the drilling of oil and gas wells. Kemp was awarded U.S. Pat. No. 4,228,762 for the invention entitled “Growth system for crustaceans and fish”. It is a system aimed at developing areas for raising and harvesting of fresh water prawn, shrimp and other crustaceans.

The prescribed art outlined above summarize some of the inventions identified as being United States Patent and Trademark office bank of awarded patents reflect work with artificial structures in a marine or aquatic environment. It is obvious that our disclosure is different from each of these inventions as well as others by its advantages in terms of cost, ease of preparation, efficiency at stimulating marine life and the environmental impact.

Studies in the scientific literature reveal developments that are published in peer reviewed journals outline some of the state of the art construction of artificial reefs. Below is a survey of the scientific literature, including some of our work in the area. This body of work helps define that what has been disclosed in this application is unique. These scientific endeavors also reveal that our invention holds the potential to positively impact the work of others in an aquatic or marine environment.

In Strangrod Lough, Northern Ireland, an experiment was conducted to determine if damaged biogenic reefs could be regenerated. These reefs were formed by the horse mussel Modiolus modiolus. The experiment showed a possible reconstruction technique that could be used to enhance the regeneration of other biogenic reefs and the mussels that are affected at different locations in the ocean.

Smaller grade building materials were randomly placed in the chambers of a large artificial reef in 1991. This increased the complexity of the habitat. A study compared the fish species that inhabited the reef before and after addition of the building materials. The fish species were then compared to fish species inhabiting a similar control artificial reef with no added complexity to the reef. The artificial reef with added complexity showed higher numbers of fish fauna and community metrics than in the control.

Water sports are said to be a major concern involving the preservation of coral reefs. These sports, such as SCUBA diving and snorkeling, can lead to increased pressures for the reefs. An increase in pressure can cause mechanical breakage and decomposition of the reefs, as well as the re-suspension of sediments which in turn covers the corals. Proposed solutions to these problems include electrolytic deposition of calcium carbonate to supplement coral growth and using artificial reefs to stabilize marine sediment.

Researchers analyzed the relationship between artificial coral reefs and natural coral reef habitats. This relationship is poorly understood. An experiment tested the artificial reefs to see whether these reefs changed the grazing pattern of the surrounding environment. The results from this experiment show that the construction of artificial reefs does in fact change the grazing patterns of the environment surrounding the reef.

Although there is no clear understanding on how artificial reefs affect the population of fish and the community dynamics in surrounding areas, it is said that artificial reefs can be used as a fishery management tool. An experiment was designed to develop a model that examined the long term effects of adding artificial reefs to an area in regards to fish weight, abundance, and biomass. The experiment was also used to study the community dynamics of the environment surrounding the reef.

Artificial coral reefs have been constructed around the world, but there is a lack of science behind the construction and ecological impact of these artificial coral reefs. This paper seeks to make recommendations about many different parameters involving the construction and ecology of artificial coral reefs. In addition to this, the paper seeks to determine the economic and social impact of these artificial coral reefs.

In order to construct a proposed artificial reef at Mount Maunganui Beach, New Zealand, a 5 year analysis/assessment was required to obtain a permit. This analysis/assessment of the reef includes determining different ecological and economic impacts the reef might have in the surrounding area. Additionally, monitoring of both the physical and biological responses of the reef were proposed programs.

The state of South Carolina has begun manufacturing artificial reefs as opposed to using scrap materials. Because there are a wide variety of materials used to construct artificial reefs, the effectiveness of said materials may differ in cost as well as ecological/biological impact. This project seeks to test the effectiveness of eight different types of manufactured artificial reefs so that different groups, such as fisheries, can enhance productivity and lower costs and ecological impacts.

One of the main limiting factors in the construction of artificial reefs is cost. However, quarry by-products provide a potential alternative. Blocks made from quarry by-products are cheap to manufacture, have very low leaching of metals, and offer a wide variety of potential reef designs while not having a negative ecological impact on the environment. This study analyzes the performance of quarry by-products as potential artificial reef construction materials.

The effectiveness of similarly designed artificial reefs in the Adriatic Sea may vary depending on size and location. By determining effectiveness, such as fishing yield and impact on fish assemblage, preferential placement of artificially constructed reefs in locations such as the Adriatic Sea can be determined. Artificial reefs can help stimulate fisheries that are near the shore by increasing the cover and space of the habitat. Growing sessile epibiota on the artificial reef can help feed some of the reef fish. Artificial reefs can eventually become very complex because of various invertebrates that attach to the artificial reef.

An artificial rock reef was built in eastern Canada. This reef was monitored by scuba divers and showed growth of complex fauna and flora which included a large number of lobsters. The amount of lobsters after two years was still less than what would be expected by a productive lobster area. Building artificial reefs on sandy bottoms is a way to decrease the amount of diving pressure that occurs on natural reefs. An experiment was conducted to test this by anchoring an artificial reef at a depth of 18 m along a wire. The study revealed that vertical artificial reefs show optimal conditions for the survival of corals.

Natural reefs tend to be more diverse and have a more complex food web, but artificial reefs have higher numbers of distinct fish species which shows their importance at a regional scale. In order to understand this, individuals need to look at the underlying relationships between complexities of a habitat which influences the fish community of the reef.

Researchers focused on artificial reefs on the southern coast of Portugal. This study looked at the chemical process of nutrient cycling by deploying an artificial reef. Two years after the artificial reef was deployed, the organisms and inorganic compounds at the bottom of the ocean showed a significant increase.

Using diver transects method, the fish communities in a natural and artificial reef site in the Botany Bay were observed over a certain period of time. Overall, the abundance, heterogeneity, and richness of the species were higher in the natural reef than the artificial. The only fish species that were higher in number in the artificial reefs were those of economic importance.

Multiple natural reefs and artificial reefs were compared to one another with a focus on the stony and soft coral community structures. The artificial reefs chosen had progressed beyond the point of their beginning successional phases. The structural stability and age of artificial reefs were responsible for community differences. The results show that heterogeneity and space for species to grow may increase which leads to increases in production and species diversity.

The Vantuna Research Group has been observing fish species near the artificial breakwaters of King Harbor, Calif. for eighteen years. Various events such as changes in water temperatures, destructive storm waves, and reconstruction of the breakwater area affected the assemblages of fish. Other than for the events just listed, fish abundance and species richness remained relatively stable over the study period. This study supports the potential of a well-designed breakwater working as a reef.

Some man-made structures placed in inshore coastal areas have caused biological and hydrographical changes to the environments they are placed in. Before placing a large artificial reef in an area, researchers conducted pre-deployment analyses. Some pre-deployment analyses included sedimentological research and divers observing the existing biological community. This study collected data to be used in evaluating the impacts and performance the artificial reef has on the area post-deployment.

A technique called mineral accretion has been developed and utilized to help prepare the metal surface for marine life. The technique involves applying a low voltage to the metallic structure which can allow calcium carbonate (limestone) to form on the surface, which can provide a friendly surface for coral growth.

By using submersibles in deep water sites off Hawaii's coast, fish communities were assessed around artificial reef modules. The study showed that the depth of the reef was most important in determining fish biomass whereas the reef material and configuration was important to determine species diversity and richness. Overall, small, deep-water artificial reefs functioned as a place for fish to aggregate rather than a place to increase fish production.

There are numerous intellectual property revelations disclosed internationally. Because of the pressure placed on the fishing industries worldwide by an expanding population, solutions are sought to make the seas more productive. Countries such as China and Japan have disclosed numerous inventions in this general area, most of which are specific designs of artificial reefs.

### SUMMARY

The goal of this invention was to provide a sustainable and economical approach to promoting marine life while adhering to the principals of green technology. A cellulose based material, such as wood, rope, paper and/or saw-dust, is soaked in a nutrient solution that includes a range of essential organic and inorganic nutrients such as sugars, phosphate, nitrates, vitamins, amino acids, proteins, citric acid, starch, silicates, carbonates, and trace levels of essential elements such as iron, copper, manganese, iodine, etc. There are over one hundred nutrient species added to the concentrate that is absorbed into the cellulose material. The cellulose based material is then weighted down with a mineral based biodegradable substrate. This substrate, which can be different types of minerals such as limestone, silicates and/or aluminate, has a density greater than water and is also seeded with nutrients such, as but not limited to, sugars, vitamins, amino acids, proteins, starch, nitrates, phosphates and iron salts. This allows for marine life to quickly grow on the dense substrate and to biodegrade over time. In a marine environment, this promotes rapid colonization and growth of microbes on the cellulose based material and the slow mineral based substrates in a matter of hours or days after submersion. These microbes are the bottom of the food chain, and quickly attract other marine creature such as copepods and fish larvae to promote the production of a reef community. With time, the original cellulose based material and nutrients are consumed and degraded and leave behind a thriving ecosystem.

### DETAILED DESCRIPTION

A material composed of cellulose, such as tree, bamboo, sugarcane, or wood products such as stems, barks or roots, are selected. These are biodegradable, can absorb nutrients and are a natural and common surface for marine organisms to colonize. A range of shapes and sizes are possible for selection from a few inches to dozens of feet. This selection is made based on the ultimate goal. For example, one may only want to grow microbes in a small confined space and would therefore select a small piece of cut wood, bundled paper, cotton, branches, etc. Another application might include a range of lumber sizes in order to not only stimulate underwater growth of microbial species but to provide shelter for fish and crabs as well.

In other cases, the wood or cellulose based material is placed in a vacuum (<1 atm) and/or gently heated to remove air and water. Once this has been achieved, the cellulose based material is then treated at atmospheric pressure or higher pressures with a nutrient mix that encourages the growth of marine life.

The surface area may be roughed by either chemically etching the surface with a mild acid such as vinegar, or by using a mechanical method such as sand paper or sand blasting the surface. In some cases the cellulose material is injected with a mineral based material such as sand or limestone in order to increase its density and cause the material to sink in an aquatic or marine environment. For example, bamboo has a hollow structure that is fill with sand that is laced with nutrients such as sugar, starch, vitamins and metal salts so it can stay on the ocean floor. Microbes such as Crocosphaera (bacteria) and coral larvae representing species such as stony Acropra staghorn corals or soft gorgonians (sea fans) are examples of organisms that would initially colonize the nutrient rich cellulose structure. In a grow-out in northern Gulf of Mexico, our method demonstrated that barnacles were formed within fourteen days of setting out the nutrient enrich cellulose structure. In and on the surface, other marine species ranging from bacterial films to small crabs and miniature shrimp were identified. The control, which was untreated wood, showed little external growth after two weeks. This cellulose and lignin based material has been a nucleation site for oysters, an important commercial product along the Gulf of Mexico coast of the Florida panhandle.

A series of controls and nutrient enriched wood was deployed on a dock in south Florida. The controls included untreated cellulose, cellulose pretreated in salt water only, cellulose pretreated with carbonate, and cellulose pretreated with only sugars. The cellulose based materials treated with the full complement of nutrients showed a rapid growth of bacterial films and attracted fish that utilized the microbes as a food source. In the situation where a dense cellulose material is utilized, holes are drilled to maximize the permeation of the nutrients into the cellulose and to provide an enclosed structure to contain minerals such as silicates, limestone and aluminates. These apertures may also provide a niche or a safe nucleation site for microbes and small creatures.

Larger structures such as cement blocks, cars, ships, etc. are often used to initiate reefs, provide a habitat for large marine life, and provide a rich location for scuba divers. These approaches can take years before life is initiated and it is often, in relation to the size of the ocean, a small scale attempt. Recent reports in the scientific literature have shown that marine life, such as sport fish and lobsters that live around an artificial reef constructed of steel, have high levels of toxic metals such as nickel and chromium. Likewise, the City of Fort Lauderdale (Florida) recently acknowledged a pollution problem and removed a large number of vehicle tires that were originally set out in the Atlantic Ocean as an artificial reef. With our approach, dozens of acres of a barren seabed can be planted with our nutrient enriched cellulose material. The cellulose and mineral based material will degrade at a rapid rate leaving behind nucleation sites for coral reefs, invertebrate collections, and more. This approach may be used to initiate growth in a fresh, brackish or saltwater environment. Applications may include the large scale remediation of oil spills, long underwater trails for tourists to follow; a method to grow shell fish for commercial applications, or a breeding ground for freshwater fish that have minimum habitat due to the clearing of shorelines for commercial reasons.

A key difference between our approach and other standard approaches in building an artificial reef is that our building materials are enriched with resources that have been proven to stimulate microbial growth in a marine environment. This allows our system to build an ecosystem from the bottom of the food chain by means of bacteria, archea, and algae. The cellulose material is soaked in the nutrient solution (Table 1) for a period of time before being secured to a mineral based substrate and then planted in a marine environment.

The United States Environmental Protection Agency (EPA) defines green technology using twelve principles or parameters. Our approach adheres to the twelve principles and would qualify as a green technology method. Below is a brief outline of each of the principles and a summary of our approaches adherence to these parameters.

1. Prevention (ft is better to prevent waste than to treat or clean up waste afterwards). The artificial reef will be constructed with pine wood, coated in a nutrient solution, and be placed in a mineral based foundation. No plastics or hazardous chemicals will be used to create the artificial reef. Small amounts of nutrients will be used such as those normally found in bodies of water.
2. Atom Economy (Design synthetic methods to maximize the incorporation of all materials used in the process into the final product). All of our starting materials are used in the final product except for the milk jugs that are used only to mold the mineral based foundation.
3. Less Hazardous Chemical Syntheses (Design synthetic methods to use and generate substances that minimize toxicity to human health and the environment). All substances are used in small, safe amounts to prevent toxicity and pollution. Most substances used are nutrients that are environmentally friendly. Both the cellulose and mineral based materials will eventually degrade rapidly without releasing toxic chemicals or substances into the environment.
4. Designing Safer Chemicals (Design chemical products to affect their desired function while minimizing their toxicity). Many of the substances used are organic in nature and nontoxic since they release small amounts of chemicals and nutrients that are already present in oceans.
5. Safer Solvents and Auxiliaries (Minimize the use of auxiliary substances wherever possible make them innocuous when used). The artificial reef will use only limited amounts of chemicals, such as iron and copper. Small amounts are used to support the reef are too small to pollute the ocean.
6. Design for Energy Efficiency (Minimize the energy requirements of chemical processes and conduct synthetic methods at ambient temperature and pressure if possible). The creation of the artificial reef was done at room temperature on land, and the reef will be placed at a shallow depth in the ocean. In addition, the minerals used are commonly available and not energy intensive. Gathering the materials and constructing the reef required minimal energy and was accomplished using common hand tools.
7. Use of Renewable Feedstock's (Use renewable raw material or feedstock rather whenever practicable). The materials to construct the artificial reef include pine wood, sugarcane, and bamboo (which are grown locally), proteins, salt, sugars, starch, fibers, vitamins and other common renewable materials.
8. Reduce Derivatives (Minimize or avoid unnecessary derivatization if possible, which requires additional reagents and generate waste). The artificial reef will only produce carbon dioxide and products from decomposition of the mineral based foundation and pine wood. The products from the decomposition of pine wood and the foundation should have only a minimal effect on the marine environment.
9. Catalysis (Catalytic reagents are superior to stoichiometric reagents). Not applicable.
10. Design for Degradation (Design chemical products so they break down into innocuous products that do not persist in the environment). The artificial reef will be made of cellulose based materials and a mineral based substrate that will degrade quite rapidly.
11. Real-time Analysis for Pollution Prevention (Develop analytical methodologies needed to allow for real-time, in-process monitoring and control prior to the formation of hazardous substances). Routine visits to the artificial reef site can be conducted to check on the progress of colonization. Visits will also be conducted to determine if there is any pollution in the area due to the artificial reef.
12. Inherently Safer Chemistry for Accident Prevention (Choose substances and the form of a substance used in a chemical process to minimize the potential for chemical accidents, including releases, explosions, and fires). All the substances will be used in small amounts to minimize any chemical accidents. The risk of explosions and fires is highly unlikely.

TABLE 1
Species are soaked into the cellulose material and then used to provide
nutrients. The concentrations vary from having mass percentages greater
than one (>1%, i.e. NaCl, sugar) to much lower concentrations (i.e.
1 ppm Cu ions). Metals listed are added in their natural oxidation states
as salts (i.e. Al₂O₃, CaCO₃, etc.)

| | | |
|---|---|---|
| Menaquinone-4 | Vanadium | Alanine |
| Magnesium | Rhamnose | Alpha chaconine |
| Lycopene | Magnesium | Arginine |
| vitamin A | Zinc | Ascorbic acid |
| saturated fatty acids | Copper | Aspartic acid |
| Niacin | Beta solanine | beta carotene |
| selenium | hemicellulose | Bromine |
| cellulose | Silicates as solids | Carboxylates |
| Gold | Cadmium | Citric acid |
| Tin | Betaine | Cystine |
| Vitamin E | | Galactose |
| vitamin B-6 | Aluminum | Glutamic acid |
| polyunsaturated fatty acids | Manganese | Glycine |
| Monounsaturated fatty acids | Lithium | Histidine |
| Riboflavin | Anhyrogalacturonic | hydrocarbons |
| | acid | |
| Fructose | zenxanthin | Isoleucine |
| Silicon | Molybdenum | Leucine |
| Starch | Chitin | Lignin |
| Strontium | pantothenic acid | Lysine |
| Iron | Titanium | Malic acid |
| Ammonia | Arabinose | Mannose |
| Clays as solids | Carbonates as solids | Metal based |
| | | minerals as solids |
| Lactose | sulfate | Methionine |
| potassium | Lectin | pectin |
| Starch | Phosphate | Phenylalanine |
| Boron | Iodine | Phytosterols |
| vitamin C | Molybdenum | Proline |
| Chloride | Carbonate | Retinol |
| calcium | Barium | Serine |
| phosphorus | Xylose | Sodium |
| Folic acid | Fructose | Thiamin |
| Nickel | Chromium | Threonine |
| Choline | Cobalt | Titer acid |
| Glucose | lutein | Tryptophan |
| Vanadium | Ammonium | Tyrosine |
| Fiber | Nitrate | Valine |
| sugars | proteins | Vitamin B |
| Proteins | alpha carotene | Vitamin B-12 |
| Sucrose | beta cryptoxanthin | Vitamin K |

Table one provides a list of chemicals that are soaked into the cellulose material and added to the mineral material. During the soaking process the goal is to saturate the material. Smaller quantities/concentrations are added to the mineral based material that is used to hold the cellulose material in place. For example; 0.1% by mass sugar, vitamins, nitrate, phosphate, and a buffer are added to the cement to encourage microbial growth and aid in its decomposition.

Elements are added in their stable oxidation states (iron=iron(II) and iron(III); zinc=Zn(II), chlorine=chloride, etc.). Some of the species will form oxides or hydroxides in a marine environment (i.e. iron to iron hydroxide, chromium to chromate or dichromate, etc.). Anions may have multiple forms (phosphate=PO₄⁻³, HPO₄⁻², H₂PO₄⁻; carbonate CO₃⁻², HCO₃⁻) and acids may be in a protonated and/or deprotonated form (i.e. Acetic acid or acetate). Hydrocarbons may be functionalized (i.e. double bonds, carboxylates, etc.). In some groups, like the sugars, proteins, minerals, and hydrocarbons, we list the major molecular species, but there are other species present in lower concentrations that are not listed.

Our group has performed research in the Gulf of Mexico, along the Florida coast, developing and demonstrating this technique as part of our Cancer Drugs From the Sea project, which has spanned over a decade. It has been used to grow a range of marine species on a surface, from bryozoans and algae to oysters and soft corals. While these sessile species colonize the surface of our nutrient laced cellulose material, it also attracts other marine life ranging from crabs to fish that feed on the colonizing creatures. While the nutrients do get consumed and dissipate from the cellulose material over time, it does provide a significant advantage to promote the rapid growth of sessile creatures, particularly microbes, at the beginning of the grow-out period. An emphasis on the green aspect to our technology is that once the cellulose and mineral material is degraded and consumed, a functioning ecosystem will be left behind that may include bryozoans, corals, sea squirts, various sea plants, etc. with marine life varying in location, depth, and time of year.

Other structures that are commonly deployed and endorsed by various government agencies include: steel based structures such as ships, bridge components, cars, and pipes. It has been reported in scientific literature that these structures can transfer toxic material such as Ni, Cr, and PCB's to marine creatures living on and around the submerged structures, which in turn work their way up the food chain and into sport fish that are caught and consumed. Our reference section provides a sample and not a complete list of research in this area. This work by the scientific community shows a clear need for an efficient, economic, and green technological approach to stimulating life in the oceans and aquatic environments.

Many structures described both in the patent literature and the scientific literature can suffer dramatically from currents and storms. While our approach does not require the cellulose based material to be secured to the ocean floor, it can be dispersed during a storm. If that does occur, the material would still continue to function as a nucleation site for marine and aquatic life, despite its new location.

### JOURNAL REFERENCES

Bailey-Brock, Julie H. 1989. Fouling community development on an artificial reef in Hawaiian waters. Bulletin of Marine Science, v. 44, no. 2, p. 580-591.
Bell M, Moore C J, Murphy S W. 1989. Utilization of manufactured reef structures in South Carolina's marine artificial reef program. Bulletin of Marine Science, v. 44, no. 2, p. 818-830.
Bohnsack J A, Sutherland D L. 1985. Artificial reef research: a review with recommendations for future priorities. Bulletin of Marine Science, v. 37, no. 1, p. 11-39.
Bombace G, Fabi G, Fiorentini L, Speranza S. 1994. Analysis of the efficacy of artificial reefs located in five different areas of the Adriatic Sea. Bulletin of Marine Science, v. 55, nos. 2-3, p. 559-580.
Burchmore J J., Pollard D A., Bell J D., Middleton M J., Pease B C., Matthews J. 1985. An ecological comparison of artificial and natural rocky reef fish communities in Botany Bay, New South Wales, Australia. Bulletin of Marine Science, v. 37 no. 1, p. 70-85.
Campbell M, Rose K, Boswell K, Cowan J. 2011. Individual based modeling of an artificial reef fish community: effects of habitat quantity and degree of refuge. Ecological modeling, v. 222, p. 3895-3909.
Charbonnel E, Serre C, Ruitton S, Harmelin J G, Jesen A. 2002. Effects of increased habitat complexity on fish assemblages associated with large artificial reef units (French Mediterranean coast). ICES Journal of Marine Science, v. 59, p. S208-S213.
Einbinder, Shai et al. 2006. Effects of artificial reefs grazing in their vicinity: evidence from algae presentation experiments. Marine Environmental Research, vo. 61, no 1, p. 110-119.
Falcao M, Santos M N, Vicente M, Monterio C C. 2007. Biogeochemcial processes and nutrient cycling within an artificial reef off Southern Portugal. Marine Environmental Research, v. 63, no. 5, p. 429-444.
Farinas-Franco J, Allcock L, Smyth D, Roberts D. 2013. Community convergence and recruitment of keystone species as performance indicators of artificial reefs. Journal of Sea Science, v. 78, p 59-74.
Gregg, K, Murphey 5.1994. The role of vessels as artificial reef material on the Atlantic and Gulf of Mexico coasts of the United States. Atlantic States Marine Fisheries, no. 38, p. 16.
Hackradt C W, Felix-Hackradt F C, Garcia-Charton J A. 2011. Influence of habitat structure on fish assemblage of an artificial reef in southern Brazil. Marine Environmental Research, v. 72, no. 5, p. 235-247. Marcus, J. M., Mathews, T. D. 1987. Polychlorinated biphenyls in blue crabs from South Carolina. Bulletin of Environmental Contamination and Toxicology, v. 39, p. 857-862.
Mathews, T. D. 1994. Contaminants in recreationally important estuarine finfish from South Carolina. Bulletin of Environmental Contamination and Toxicology, v. 53, p. 412-419.
Mathews, T. D., Bell, M. 1994. Heavy metal and PAH uptake on tire/concrete artificial reef units off South Carolina. USF&WS Sportfish Restoration Project, no. 2, p. 11.
Mead S, Black K. 1999. A multipurpose, artificial reef at Mount Maunganui Beach, New Zealand. Coastal Management, v. 27, no. 4, p. 355-365.
Mearns, J. A., Simececk-Beatty, D., Buchman M. F., Shigenaka, G., Wert, W. A., 1988. PCB and Chlorinated Pesticide Contamination in U.S. Fish and Shellfish: A Historical Assessment Report. NOAA Technical Memorandum, no. 39, p. 40.
Moffitt R B, Parrish F A, Polovina J J. 1989. Community structure, biomass and productivity of deep-water artificial reefs in Hawaii. Bulletin of Marine Science, v. 44 no. 2, p. 616-630.
Naucen, C. E. 1983. Compilation of legal limits for hazardous substances in fish and fishery products. Food and Agricultural Fisheries Circular, Food and Agricultural Organization of the United Nations, no. 764.
NOAA. 1987. National Status and Trends Program for Marine Environmental Quality: Progress Report: A summary of selected data on chemical contaminants in tissues collected during 1984, 1985, and 1986. NOAA Technical Memorandum. NOS OMA 38. p. 22.
Oren U, Benayahu Y. 1997. Transplantation of juvenile corals: a new approach for enhancing colonization of artificial reefs. Marine Biology, v. 127, no. 3, p. 499-505.
Perkol-Finkel S, Benayahu Y. 2004. Community structure of stony and soft corals on verticalunplanned artificial reefs in Eilat (Red Sea): comparison to natural reefs. International Society for reef Studies, v. 23 no. 2, p. 195-205.
Richards, V. L. 2003. Corrosion survey of the former naval vessel HMAS Hobart. Department of Materials Conservation, Western Australian Museum, Perth.
Richards, V. L. 2003. Corrosion survey of the former naval vessel HMAS Hobart. Department of Materials Conservation, Western Australian Museum, Perth.
Scarratt D J. 1965. An artificial reef for lobsters. Journal of the Fisheries Research Board of Canada, v. 25, no. 1, p. 2683-2690.
Schmitt, C. J., Zajiik, J. L. Ribick, M. A. 1985. National Pesticide Monitoring Program: Residues of organochlorine chemicals in freshwater fish, 1980-81. Archives of Environmental Contamination and Toxicology, v. 14, p. 225-260.
Stephens Jr, John S, Morris P A, Pondella D J, Koonce T A, Jordan G A. 1994. Overview of the dynamics of an urban artificial reef fish assemblage at King Harbor, Calif., USA, 1974-1991: a recruitment driven system. Bulletin of Marine Science, v. 55 no. 2-3, p. 1224-129.
Treeck P, Schuhmacher H. 1999. Artificial reefs created by electrolysis and coral transplantation: An approach ensuring the compatibility of environmental protection and diving tourism. Estuarine Costal and Shelf Science, v. 49, no. 1, p. 75-81.
Wilding T A, Sayer M D J. 2002. Evaluating artificial reef performance: approaches to pre- and post-deployment research. ICES Journal of Marine Science, v. 59, p. 222-230.
Wilding T A, Sayer M D J. 2002. The physical and chemical performance of artificial reef blocks made using quarry by-products. ICES Journal of Marine Science, v. 59, p. 250-257.

Related U.S. Pat. No.

| | | |
|---|---|---|
| 137659 | April 1873 | Cunningham |
| 934666 | Sep-09 | Goldkamp |
| 1,456,058 | May-23 | Hale |
| 1,556,401 | Oct-25 | Beckmann |
| 2,017,090 | Oct-35 | Eggert, Jr. |
| 2,270,229 | Jan-42 | Neff |
| 2,396,226 | Mar-46 | Aston |
| 3,238,279 | Mar-66 | Tarlton et al. |
| 3,309,876 | Mar-67 | Potter |
| 3,426,109 | Feb-69 | Dempster |
| 3,499,421 | Mar-70 | MacDonald et |
| | | al. |
| 3,548,600 | Dec-70 | Stolk, Jr. et al. |
| 3,628,334 | Dec-71 | Coleman |
| 3,643,910 | Feb-72 | Heifetz |
| 3,704,687 | Dec-72 | Nohmura |
| 3,734,670 | May-73 | Stickler, Jr. |
| 4,047,962 | Sep-77 | Copeland |
| 4,083,190 | Apr-78 | Pey |
| 4,239,568 | Dec-80 | Takazawa |
| 4,301,612 | Nov-81 | Ciulla |
| 4,432,638 | Feb-84 | Tarsia |
| 4,468,885 | Sep-84 | Mandish |
| 4,508,057 | Apr-85 | Suzuki |
| 4,601,080 | Jul-86 | Cook |
| 4,712,944 | Dec-87 | Rose |
| 4,840,516 | Jun-89 | Rambo |
| 4,843,112 | Jun-89 | Gerhart et al. |
| 4,844,015 | Jul-89 | Garvey et al. |
| 4,856,935 | Aug-89 | Haras |
| 4,993,362 | Feb-91 | Jimbo |
| 4,996,943 | Mar-91 | Garvey |
| 4,997,311 | Mar-91 | Van Doren |
| 4,997,311 | Mar-91 | Van Doren |
| 5,071,285 | Dec-91 | Van Doren |
| 5,122,015 | Jun-92 | Shen |
| 5,215,406 | Jun-93 | Hudson |
| 5,269,254 | Dec-93 | Gagliano et al. |
| 5,536,112 | Jul-96 | Oertel, II |
| 5,564,369 | Oct-96 | Barber et al. |
| 5,596,947 | Jan-97 | Creppel et al. |
| 5,620,280 | Apr-97 | Melby et al. |
| 5,628,280 | May-97 | Ericsson |
| 5,640,800 | Jun-97 | Peterson |
| 5,803,660 | Sep-98 | Warren et al. |
| 6,186,702 | Feb-01 | Bartkowski |
| 6,464,429 | Oct-02 | Moore |
| 6,712,024 | Mar-04 | Hall |
| 6,824,327 | Nov-04 | Walter |
| 6,896,445 | May-05 | Engler |
| 6,897,382 | May-05 | Hager et al. |
| 7,144,196 | Dec-06 | Campbell et al. |

Foreign Patents

| | | |
|---|---|---|
| 2627951 | Sep-89 | FR |
| 1179634 | Jul-89 | JP |
| 5098654 | Apr-93 | JP |
| 2000178057 | Jun-00 | JP |
| 2006025720 | Feb-06 | JP |
| WO 01/19180 | Mar-01 | WO |
| 20310089 | 38322 | DE |
| 1.02004E+11 | 38626 | DE |
| 1466523 | 38261 | EP |
| 2270664 | 34394 | GB |
| WO 2004/075633 | 38231 | WO |
| WO 2004075633 | 38231 | WO |

1. A treated cellulose based structure, with a total density greater than water and impregnated with organic and inorganic nutrients and inert material, that follows the concept of green technology, is used to promote the growth of life in a fresh or salt water environment.

2. A method according to claim 1 in which the structure may be treated physically or chemically to maximize its surface area and ability for absorbing or containing nutrients and inert material to grow microbes in a aquatic or marine environment.

3. A method according to claim 1 in which one component of the biodegradable structure is composed of nutrient treated cellulose based material such as, but not limited to: wood, bark, bamboo, sugarcane, cotton, sawdust, rope, or paper.

4. The method according to claim 1 where the cellulose structure is embedded with a inert material mixture that may contain one or more of the following but is not limited to silicates, carbonates, metal oxides, metal hydroxides and aluminates, each with a density higher than water in their natural state. 14. An artificial reef as claimed in claim 1 where the treated cellulose material is submerged in a water environment such as the ocean, bay, or a freshwater site such as a lake or a river and serves such as colonization site for aquatic and marine life.

5. An artificial reef as claimed in claim 1 where the treated cellulose material serves the start an ecosystem from the bottom of the food chain, promoting rapid colonization by microbes such as bacteria and/or algae.

6. An artificial reef as claimed in claim 1 where the treated cellulose material serves as a platform or provides protection for environmentally critical sessile species such as but not limited to corals, barnacles, sponges, bryozoans, and sea squirts.

7. An artificial reef as claimed in claim 1, with the establishment of the microbial community, it becomes a feeding site and habitat for commercially viable species such as but not limited to fish, crabs, eels, and lobster.

8. An artificial reef as claimed in claim 1, where the cellulose material serves as a platform for commercial viable sessile species such as but not limited to oysters, clams, and mussels.

9. An artificial reef as claimed in claim 1 where the treated cellulose material serves as a platform for sessile organisms that may contain molecules of some medicinal interest.

10. An artificial reef as claimed in claim 1 where the treated cellulose and its nutrient materials slowly decay and are consumed, leaving behind a new and functioning ecosystem.

11. A method according to claim 1 in which the cellulose based structure is soaked in environmentally friendly nutrients to promote growth of marine and aquatic life.

12. The method according to claim 11 where these nutrient materials include various sugars such as but not limited to monosaccharides and disaccharides.

13. The method according to claim 11 where the nutrient materials include but are not limited to various inorganic species such as nitrates, phosphates, iron(II), iron(III), copper(II), chlorides, iodides, sulfate, calcium(II), and zinc(II).

14. The method according to claim 11 where these nutrient materials may include various organic species that are carboxylates and carboxylic acids, such as but not limited to citrates, citric acid, acetic acid and acetates.

15. The method according to claim 11 where these nutrient materials may include various proteins and their building blocks such as amino acids and peptides.

16. The method according to claim 11 where these added nutrient materials include various vitamins such as but not limited to vitamin A, vitamin C, multiple vitamin B's, vitamin D and vitamin E.

17. The method according to claim 11 where added nutrients can take the form of a natural substance such as but not limited to honey, orange juice, liquefied potatoes and milk.

18. The method according to claim 11 where the nutrients include natural polymers such as but not limited to chitin and lignin.

19. The method according to claim 11 where these nutrient materials include various hydrocarbon molecules that may be functionalized with other elements and/or double bonds such as but not limited to palmatic acid, stearic acid and squalene.

20. The cellulose artificial reef is constructed of materials that are biodegradable or found in the existing ecosystem naturally.
